(19) United States
(12) Patent Application Publication
(10) Pub. No.: US 2024/0021356 A1
(43) Pub. Date: Jan. 18, 2024

(54) POWER INDUCTOR DEVICE FOR AND MANUFACTURING METHOD THEREOF

(71) Applicant: TRIO Technology Co., Ltd. Seychelles Taiwan Branch, New Taipei City (TW)

(72) Inventors: Huo-Li LIN, New Taipei City (TW); Jin-Huo RAO, Hubei Province (CN); Ta-Wei WEI, Taichung City (TW)

(21) Appl. No.: 18/351,002

(22) Filed: Jul. 12, 2023

Related U.S. Application Data
(60) Provisional application No. 63/368,176, filed on Jul. 12, 2022.

(51) Int. Cl. H01F 27/255; H01F 27/30; H01F 1/147; H01F 41/04; H01F 41/02

(52) U.S. Cl. CPC H01F 27/255; H01F 27/306; H01F 1/147; H01F 41/04; H01F 41/0246

(57) ABSTRACT

A power inductor device and a manufacturing method thereof are provided. The power inductor device includes a magnetic core body and a metal conductor. The magnetic core body is formed by a magnetic powder. The metal conductor is disposed in the magnetic core body and two ends of the metal conductor are exposed outside the magnetic core body. The magnetic powder is closely combined with the metal conductor and the magnetic powder is partially embedded into a skin layer of the metal conductor to obtain an integrated power inductor structure with crystallized structures. The magnetic core and the metal conductor are assembled and formed by a heating and pressing molding process, and the crystallized structures are generated by a section heating process, a calcining process, a tempering process and a cooling process.

### CROSS-REFERENCE TO RELATED APPLICATION

This application claims the benefit of U.S. Provisional Application No. 63/368,176, filed on Jul. 12, 2022, the disclosure of which is incorporated by reference herein in its entirety.

### BACKGROUND OF THE INVENTION

### 1. Field of the Invention

The present invention generally relates to a power inductor and a manufacturing method thereof, and in particular, to the integrated power inductor with good inductance value, saturation current capability, better working bandwidth and excellent production convenience.

### 2. Description of the Related Art

Due to the continuous development of the electronic products, the functional requirements are getting higher and higher, and the requirements for superimposed current are also increasing. While pursuing high efficiency, the loss of the inductive powder materials is also getting smaller and smaller. At the same time, the electromagnetic interference (EMI) and magnetic flux leakage problem are the urgent task for electronic product development.

The conventional inductor is made by two-piece ferrite and a metal conductor between the two cores. The two cores and the metal conductor are bonded by glue. The combined high-power inductor may have high saturation current, but when the current load is fully loaded, the inductance value will directly decay to zero. That is, the circuit may be unable to operate, the ripple current may increase, and even the board will be burned. In addition, the ferrite two-piece power inductor often falls off due to the problems in the dispensing process. The air gap generated in the dispensing process may cause magnetic flux leakage, resulting in EMI problem.

In summary, the conventional power inductor and the manufacturing method thereof still has considerable problems. Hence, the present disclosure provides the power inductor device and the manufacturing method thereof to resolve the shortcomings of conventional technology and promote industrial practicability.

### SUMMARY OF THE INVENTION

In view of the aforementioned technical problems, the primary objective of the present disclosure is to provide the power inductor and the manufacturing method thereof, which are capable of increasing inductance value, maintaining saturation current capability, increasing working bandwidth and resolving the production problems.

In accordance with one objective of the present disclosure, a power inductor device is provided. The power inductor device includes a magnetic core body and a metal conductor. The magnetic core body is formed by a magnetic powder and the magnetic powder has a particle size range between 10 nm-35 μm. The metal conductor is disposed in the magnetic core body and two ends of the metal conductor are exposed outside the magnetic core body. The magnetic powder is closely combined with the metal conductor and the magnetic powder is partially embedded into a skin layer of the metal conductor to obtain an integrated power inductor structure with crystallized structures. wherein the magnetic core and the metal conductor are assembled and formed by a heating and pressing molding process, and the crystallized structures are generated by a section heating process, a calcining process, a tempering process and a cooling process.

Preferably, the magnetic powder may include an iron-based soft magnetic powder mixed with an adhesive, the iron-based soft magnetic powder include carbonyl (CIP), iron silicon chromium (Fe—Si—Cr), iron silicon aluminum (Fe—Si—Al), iron silicon (Fe—Si), amorphous, nanocrystalline alloy, iron nickel (FeNi), MPP iron nickel molybdenum (FeNiMo—C), silicon (Si), iron cobalt nickel (Fe—Co—Ni), manganese zinc (MnZn), nickel zinc (NiZn) or a combination thereof, the adhesive include an organic resin, an epoxy resin or an aldehyde resin having 1.5%-4.5% of unit weight.

Preferably, the magnetic powder may further include nickel (Ne), manganese (Mn), magnesium (Mg), copper (Cu), zinc (Zn), boron (B), lithium (Li), sodium (Na), carbon (C), cobalt (Co), niobium (Nb), barium (Ba), palladium (Pd), potassium (K), bismuth (Bi), graphene, amorphous, nanocrystalline (Nanocrystalline Alloy), a combination of above metals, or metal oxide or metal carbonate with above metals.

Preferably, the particle size may include a first particle size, a second particle size and a third particle size, the first particle size is 10 nm-5 μm, the second particle size is 8.5 μm-15 μm, and the third particle size is 18 μm-35 μm.

Preferably, the metal conductor may be made by gold, silver, copper, nickel or aluminum.

Preferably, the magnetic core body may include a first cover core, a first magnetic core and a second cover core, the magnetic powders for forming the first cover core, the first magnetic core and the second cover core are the same or different. Wherein the first magnetic core is a rectangle structure having a first groove at one side and a second groove at another side, a columnar magnetic body is disposed between the first groove and the second groove to form a first U-shaped groove and a second U-shaped groove, the first U-shaped groove has first openings at both ends and the second U-shaped groove has second openings at both ends. Wherein the first cover core is a plate structure having a first channel corresponding to the first U-shaped groove. Wherein the second cover core is another plate structure having a second channel corresponding to the second U-shaped groove, the first U-shaped groove and the second U-shaped groove are not connected. Wherein the metal conductor includes a first metal conductor and a second metal conductor, the first metal conductor is disposed in the first U-shaped groove and two ends of the first metal conductor pass through the first openings, the second metal conductor is disposed in the second U-shaped groove and two ends of the second metal conductor pass through the second openings.

Preferably, the magnetic core body may include a first magnetic core and a cover core, the magnetic powders for forming the first magnetic core and the cover core are the same or different. Wherein the first magnetic core is a rectangle structure having a groove at one side and a columnar magnetic body is disposed in the groove to form a U-shaped groove, the U-shaped groove has openings at both ends. Wherein the cover core is a plate structure having a channel corresponding to the U-shaped groove. Wherein the metal conductor is disposed in the U-shaped groove and two ends of the metal conductor pass through the openings.

Preferably, the magnetic core body may include a first magnetic core, a second magnetic core and a cover core, the magnetic powders for forming the first magnetic core, the second magnetic core and the cover core are the same or different. Wherein the first magnetic core is a rectangle structure having a first groove at one side and a columnar magnetic body is disposed in the first groove to form a first U-shaped groove, the first U-shaped groove has first openings at both ends. Wherein the second magnetic core is another rectangle structure having a second groove at one side and a first channel at another side corresponding to the first U-shaped groove, a columnar magnetic body is disposed in the second groove to form a second U-shaped groove, the second U-shaped groove has second openings at both ends. Wherein the cover core is a plate structure having a second channel corresponding to the second U-shaped groove, the first U-shaped groove and the second U-shaped groove are not connected. Wherein the metal conductor includes a first metal conductor and a second metal conductor, the first metal conductor is disposed in the first U-shaped groove and two ends of the first metal conductor pass through the first openings, the second metal conductor is disposed in the second U-shaped groove and two ends of the second metal conductor pass through the second openings.

Preferably, the magnetic core body may include a first magnetic core and a bar core, the magnetic powders for forming the first magnetic core and the bar core are the same or different; wherein the first magnetic core is a rectangle structure having a groove at one side, Wherein the bar core is a columnar body disposed in the groove for forming a U-shaped groove, the U-shaped groove has openings at both ends. Wherein the metal conductor is disposed in the U-shaped groove and two ends of the metal conductor pass through the openings.

Preferably, the magnetic core body may include a first magnetic core and a bar core, the magnetic powders for forming the first magnetic core and the bar core are the same or different. Wherein the first magnetic core is a rectangle structure having a groove at one side. Wherein the bar core is a cross cylinder body disposed in the groove for forming a first U-shaped groove and the second U-shaped groove, the first U-shaped groove has first openings at both ends and the second U-shaped groove has second openings at both ends, the first U-shaped groove and the second U-shaped groove are not connected. Wherein the metal conductor includes a first metal conductor and a second metal conductor, the first metal conductor is disposed in the first U-shaped groove and two ends of the first metal conductor pass through the first openings, the second metal conductor is disposed in the second U-shaped groove and two ends of the second metal conductor pass through the second openings.

Preferably, the magnetic core body may include rectangular shape, E shape, I shape, U shape, rectangular shape with single groove, rectangular shape with dual grooves, rectangular shape with multiple grooves, polygonal shape with single groove, polygonal shape with dual grooves or polygonal shape with multiple grooves.

Preferably, a coil number of the metal conductor may be 0.25N and N is an integer of 2 or more.

Preferably, forming pressure of the heating and pressing molding process may be 5-15 T/cm³.

Preferably, the section heating process may heat up the magnetic core and the metal conductor from 25° C. to 850° C. in gradual section, the process time of the calcining process and the tempering process is 5-12 hours, and the cooling process cools down to 25° C. in gradual section.

Preferably, the power inductor device may further include an insulation layer, the insulation layer covers outside surface of the magnetic core body and the two ends of the metal conductor are exposed outside the insulation layer.

In accordance with one objective of the present disclosure, manufacturing method of a power inductor device is provided. The manufacturing method includes following steps of: providing a magnetic core body and a metal conductor, the magnetic core body being formed by a magnetic powder and the magnetic powder having a particle size range between 10 nm-35 μm; assembling the magnetic core body and the metal conductor, the metal conductor being placing in the magnetic core body and two ends of the metal conductor being exposed outside the magnetic core body; conducting a heating and pressing molding process to the magnetic core body and the metal conductor to form a combination structure; conducting a section heating process, a calcining process, a tempering process and a cooling process to the combination structure to obtain an integrated power inductor structure with crystallized structures.

Preferably, the magnetic powder may include an iron-based soft magnetic powder mixed with an adhesive, the iron-based soft magnetic powder include carbonyl (CIP), iron silicon chromium (Fe—Si—Cr), iron silicon aluminum (Fe—Si—Al), iron silicon (Fe—Si), amorphous, nanocrystalline alloy, iron nickel (FeNi), MPP iron nickel molybdenum (FeNiMo—C), silicon (Si), iron cobalt nickel (Fe—Co—Ni), manganese zinc (MnZn), nickel zinc (NiZn) or a combination thereof, the adhesive include an organic resin, an epoxy resin or an aldehyde resin having 1.5%-4.5% of unit weight.

Preferably, the magnetic powder may further include nickel (Ne), manganese (Mn), magnesium (Mg), copper (Cu), zinc (Zn), boron (B), lithium (Li), sodium (Na), carbon (C), cobalt (Co), niobium (Nb), barium (Ba), palladium (Pd), potassium (K), bismuth (Bi), graphene, amorphous, nanocrystalline (Nanocrystalline Alloy), a combination of above metals, or metal oxide or metal carbonate with above metals.

Preferably, the particle size may include a first particle size, a second particle size and a third particle size, the first particle size is 10 nm-5 μm, the second particle size is 8.5 μm-15 μm, and the third particle size is 18 μm-35 μm.

Preferably, the metal conductor may be made by gold, silver, copper, nickel or aluminum.

Preferably, the manufacturing method may further include the steps of: providing a first magnetic core with a rectangle structure having a first groove at one side and a second groove at another side, a columnar magnetic body is disposed between the first groove and the second groove to form a first U-shaped groove and a second U-shaped groove, the first U-shaped groove has first openings at both ends and the second U-shaped groove has second openings at both ends; providing a first cover core with a plate structure having a first channel corresponding to the first U-shaped groove; placing a first metal conductor in the first U-shaped groove and two ends of the first metal conductor pass through the first openings; providing a second cover core with another plate structure having a second channel corresponding to the second U-shaped groove, the first U-shaped groove and the second U-shaped groove are not connected; placing a second metal conductor in the second U-shaped groove and two ends of the second metal conductor pass through the second openings.

Preferably, the manufacturing method may further include the steps of: providing a first magnetic core with a rectangle structure having a groove at one side and a columnar magnetic body is disposed in the groove to form a U-shaped groove, the U-shaped groove has openings at both ends; providing a cover core with a plate structure having a channel corresponding to the U-shaped groove; placing the metal conductor in the U-shaped groove and two ends of the metal conductor pass through the openings.

Preferably, the manufacturing method may further include the steps of: providing a first magnetic core with a rectangle structure having a first groove at one side and a columnar magnetic body is disposed in the first groove to form a first U-shaped groove, the first U-shaped groove has first openings at both ends; providing a second magnetic core with another rectangle structure having a second groove at one side and a first channel at another side corresponding to the first U-shaped groove, a columnar magnetic body is disposed in the second groove to form a second U-shaped groove, the second U-shaped groove has second openings at both ends; providing a cover core with a plate structure having a second channel corresponding to the second U-shaped groove, the first U-shaped groove and the second U-shaped groove are not connected; placing a first metal conductor in the first U-shaped groove and two ends of the first metal conductor pass through the first openings; placing a second metal conductor in the second U-shaped groove and two ends of the second metal conductor pass through the second openings.

Preferably, the manufacturing method may further include the steps of: providing a first magnetic core with a rectangle structure having a groove at one side; providing a bar core with a columnar body, the columnar body and the first magnetic core form a U-shaped groove and the U-shaped groove has openings at both ends; placing the metal conductor in the U-shaped groove and two ends of the metal conductor pass through the openings.

Preferably, the manufacturing method may further include the steps of: providing a first magnetic core with a rectangle structure having a groove at one side; providing a bar core with a cross cylinder body, the bar core and the first magnetic core form a first U-shaped groove and the second U-shaped groove, the first U-shaped groove has first openings at both ends and the second U-shaped groove has second openings at both ends, the first U-shaped groove and the second U-shaped groove are not connected; placing a first metal conductor in the first U-shaped groove and two ends of the first metal conductor pass through the first openings; placing a second metal conductor in the second U-shaped groove and two ends of the second metal conductor pass through the second openings.

Preferably, the magnetic core body may include rectangular shape, E shape, I shape, U shape, rectangular shape with single groove, rectangular shape with dual grooves, rectangular shape with multiple grooves, polygonal shape with single groove, polygonal shape with dual grooves or polygonal shape with multiple grooves.

Preferably, a coil number of the metal conductor may be 0.25N and N is an integer of 2 or more.

Preferably, forming pressure of the heating and pressing molding process may be 5-15 T/cm³.

Preferably, the section heating process may heat up the magnetic core and the metal conductor from 25° C. to 850° C. in gradual section, the process time of the calcining process and the tempering process is 5-12 hours, and the cooling process cools down to 25° C. in gradual section.

Preferably, an insulation layer may be formed by spray painting to cover outside surface of the magnetic core body and the two ends of the metal conductor are exposed outside the insulation layer after a laser stripping process and an electroplating treatment.

As mentioned previously, the power inductor and the manufacturing method thereof may have one or more advantages as follows.

1. The power inductor and the manufacturing method thereof are capable of forming the integrated power inductor structure. The magnetic core body and the metal conductor are closely combined without generating air gap during the manufacturing process, so as to improve the characteristics of the power inductor device.

2. The power inductor and the manufacturing method thereof may easily assemble the magnetic core body and the metal conductor in the assembly process. In addition, the particle size and the material of the magnetic core body may provide excellent process yield and reduce the production cost.

3. The power inductor and the manufacturing method thereof may provide the integrated power inductor with good inductance value, saturation current capability, better working bandwidth.

### BRIEF DESCRIPTION OF THE DRAWINGS

The technical features, detail structures, advantages and effects of the present disclosure will be described in more details hereinafter with reference to the accompanying drawings that show various embodiments of the invention as follows.

FIG. 1A to FIG. 1D are schematic diagrams of the power inductor device and manufacturing method of the power inductor device in accordance with the first embodiment of the present disclosure.

FIG. 2A and FIG. 2B are schematic diagrams of the power inductor device and manufacturing method of the power inductor device in accordance with the second embodiment of the present disclosure.

FIG. 3A and FIG. 3B are schematic diagrams of the power inductor device and manufacturing method of the power inductor device in accordance with the third embodiment of the present disclosure.

FIG. 4A to FIG. 4C are schematic diagrams of the power inductor device and manufacturing method of the power inductor device in accordance with the fourth embodiment of the present disclosure.

FIG. 5A to FIG. 5C are schematic diagrams of the power inductor device and manufacturing method of the power inductor device in accordance with the fifth embodiment of the present disclosure.

### DETAILED DESCRIPTION OF THE PREFERRED EMBODIMENTS

In order to facilitate the understanding of the technical features, the contents and the advantages of the present disclosure, and the effectiveness thereof that can be achieved, the present disclosure will be illustrated in detail below through embodiments with reference to the accompanying drawings. The diagrams used herein are merely intended to be schematic and auxiliary to the specification, but are not necessary to be true scale and precise to the configuration after implementing the present disclosure. Thus, it should not be interpreted in accordance with the scale and the configuration of the accompanying drawings to limit the scope of the present disclosure on the practical implementation.

As those skilled in the art would realize, the described embodiments may be modified in various different ways. The exemplary embodiments of the present disclosure are for explanation and understanding only. The drawings and description are to be regarded as illustrative in nature and not restrictive. Similar reference numerals designate similar elements throughout the specification.

It is to be acknowledged that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

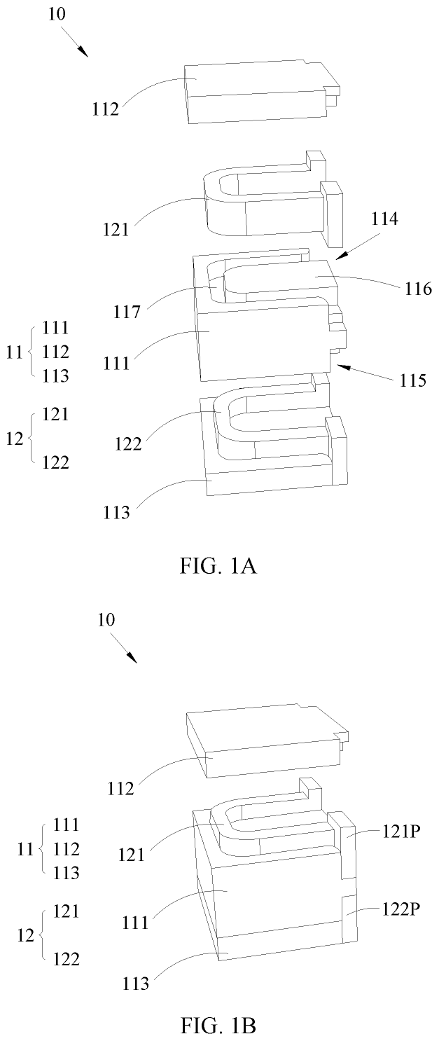

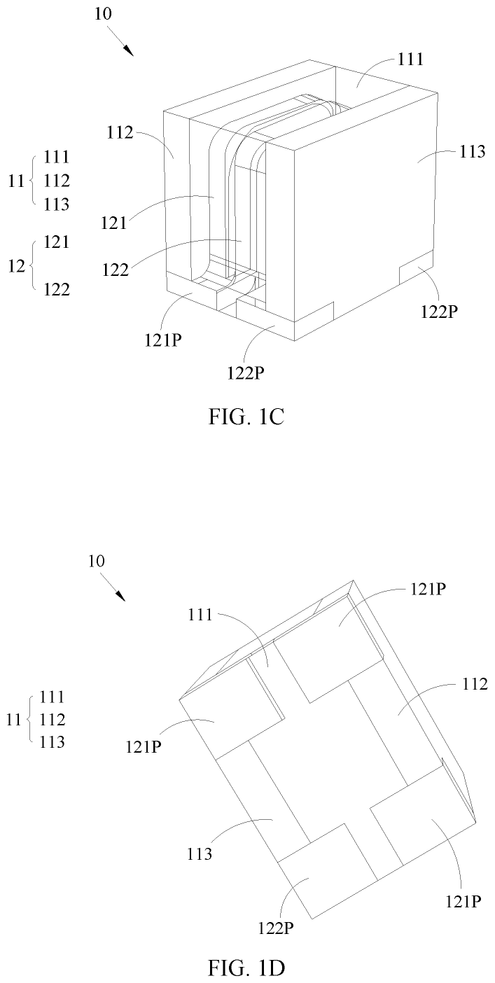

Please refer to FIG. 1A to FIG. 1D, which are the schematic diagrams of the power inductor device and manufacturing method of the power inductor device in accordance with the first embodiment of the present disclosure. FIG. 1A and FIG. 1B are the schematic diagrams of the manufacturing the power inductor device 10. FIG. 1C and FIG. 1D are the schematic diagrams of the power inductor device 10.

As shown in FIG. 1A and FIG. 1B, the power inductor device 10 includes a magnetic core body 11 and a metal conductor 12. The magnetic core body 11 includes a first magnetic core 111, a first cover core 112 and a second cover core 113. The metal conductor 12 includes a first metal conductor 121 and a second metal conductor 122. The first magnetic core 111 is a rectangle structure having a first groove 114 at one side and a second groove 115 at another side. As shown in the FIG. 1A, the first groove 114 is at top side of the first magnetic core 111 and the second groove 115 us at bottom side of the first magnetic core 111. A columnar magnetic body 116 is disposed between the first groove 114 and the second groove 115 to form a first U-shaped groove 117 and a second U-shaped groove (on the other side), the first U-shaped groove 117 has first openings at both ends and the second U-shaped groove has second openings at both ends. The first openings and the second openings facing the same direction. The first U-shaped groove and the second U-shaped groove are not connected.

The first cover core 112 is a plate structure having a first channel corresponding to the first U-shaped groove 117. That is, the first channel is also U-shape. When the first cover core 112 covers the top side of the first magnetic core 111, the first U-shaped groove 117 and the first channel may form a space for disposing the first metal conductor 121. Similarly, the second cover core 113 is another plate structure having a second channel corresponding to the second U-shaped groove. When the second cover core 113 covers the bottom side of the first magnetic core 111, the second U-shaped groove and the second channel may form another space for disposing the second metal conductor 122. In the present embodiment, the magnetic core body 11 may be rectangular shape with dual U-shape grooves and plate structure in I shape. However, the present disclosure is not limited to these structures. In other embodiment, the magnetic core body 11 may include rectangular shape, E shape, U shape, rectangular shape with single groove, rectangular shape with multiple grooves, polygonal shape with single groove, polygonal shape with dual grooves or polygonal shape with multiple grooves.

As shown in the FIG. 1B, the first metal conductor 121 is placed in the first U-shaped groove and two ends of the first metal conductor 121 pass through the first openings. The second metal conductor 122 is placed in the second U-shaped groove and two ends of the second metal conductor 122 pass through the second openings. The first cover core 112 covers the first magnetic core 111 and the first metal conductor 121. The second cover core 113 covers the first magnetic core 111 and the second metal conductor 122. The two ends of the first metal conductor 121 pass through the first openings, the two ends of the second metal conductor 122 pass through the second openings. That is, the magnetic core body 11 and the metal conductor 12 are assembled by an assembly process. The two ends of the metal conductor 12 are exposed outside the magnetic core body 11. The metal conductor 12 may be made by gold, silver, copper, nickel or aluminum. The metal conductor 12 may be a metal coil. The coil number of the metal conductor 12 may be 0.25N and N is an integer of 2 or more. The two ends of the metal conductor 12 can be bended toward inside or outside the device to form the electrode pins of the power inductor device 10. The bended coil may increase the welding area and welding strength of the electrode pins. In the present embodiment, the first metal conductor 121 has two pins 121P and the second metal conductor 122 has two pins 122P.

After the assembly process, a heating and pressing molding process is conducted to the magnetic core body 11 and the metal conductor 12 to form a combination structure. The forming pressure of the heating and pressing molding process may be 5-15 T/cm³. After that, a section heating process, a calcining process, a tempering process and a cooling process are conducted to the combination structure to obtain an integrated power inductor structure with crystallized structures.

The crystallized structures mean that the magnetic powder of the magnetic core body 11 is closely combined with the metal conductor 12 and the magnetic powder is partially embedded into a skin layer of the metal conductor 12 to obtain an integrated power inductor structure. In the present embodiment, the section heating process may heat up the magnetic core and the metal conductor from 25° C. to 850° C. in gradual section, the process time of the calcining process and the tempering process is 5-12 hours, and the cooling process cools down to 25° C. in gradual section.

In order to make the crystallized structures, the magnetic core body 11 may be formed by a magnetic powder and the magnetic powder has a particle size range between 10 nm-35μm. In the present embodiment, the magnetic powder for forming the first magnetic core 111, the first cover core 112 and the second cover core 113 are the same or different. The magnetic powder may include an iron-based soft magnetic powder mixed with an adhesive, the iron-based soft magnetic powder include carbonyl (CIP), iron silicon chromium (Fe—Si—Cr), iron silicon aluminum (Fe—Si—Al), iron silicon (Fe—Si), amorphous, nanocrystalline alloy, iron nickel (FeNi), MPP iron nickel molybdenum (FeNiMo—C), silicon (Si), iron cobalt nickel (Fe—Co—Ni), manganese zinc (MnZn), nickel zinc (NiZn) or a combination thereof, the adhesive include an organic resin, an epoxy resin or an aldehyde resin having 1.5%-4.5% of unit weight. In addition, the magnetic powder may further include nickel (Ne), manganese (Mn), magnesium (Mg), copper (Cu), zinc (Zn), boron (B), lithium (Li), sodium (Na), carbon (C), cobalt (Co), niobium (Nb), barium (Ba), palladium (Pd), potassium (K), bismuth (Bi), graphene, amorphous, nanocrystalline (Nanocrystalline Alloy), a combination of above metals, or metal oxide or metal carbonate with above metals.

In the present embodiment, the particle size of the magnetic powder may include a first particle size, a second particle size and a third particle size. The first particle size is the smallest powder and the particle size is 10 nm-5 μm. The second particle size is the middle powder and the particle size is 8.5 μm-15 μm. The third particle size is the largest powder and the particle size is 18 μm-35 μm. The smaller size powder may lower the powder loss, lower the magnetic permeability and so as to obtain the better magnetic saturation capability. However, the smaller size powder is more expensive than the larger size powder. Using different sizes of the powder may obtain a balance between the effectiveness and the cost.

As shown in FIG. 1C and FIG. 1D, the power inductor device 10 is the integrated power inductor structure. The magnetic core body 11 is closely combined with the metal conductor 12 without generating air gap during the manufacturing process. Therefore, the characteristics of the inductor can be improved. The integrated power inductor structure also inhibits the split up or fall off problem between the magnetic core body 11 and the metal conductor 12. In other embodiment, the power inductor device 10 may further include an insulation layer, the insulation layer covers outside surface of the magnetic core body 11 and the two ends of the metal conductor are exposed outside the insulation layer. The insulation layer may be formed by spray painting process. After spray painting process, a laser stripping process and an electroplating treatment can be used to remove partial insulation layer for exposing the two ends of the metal conductor 12.

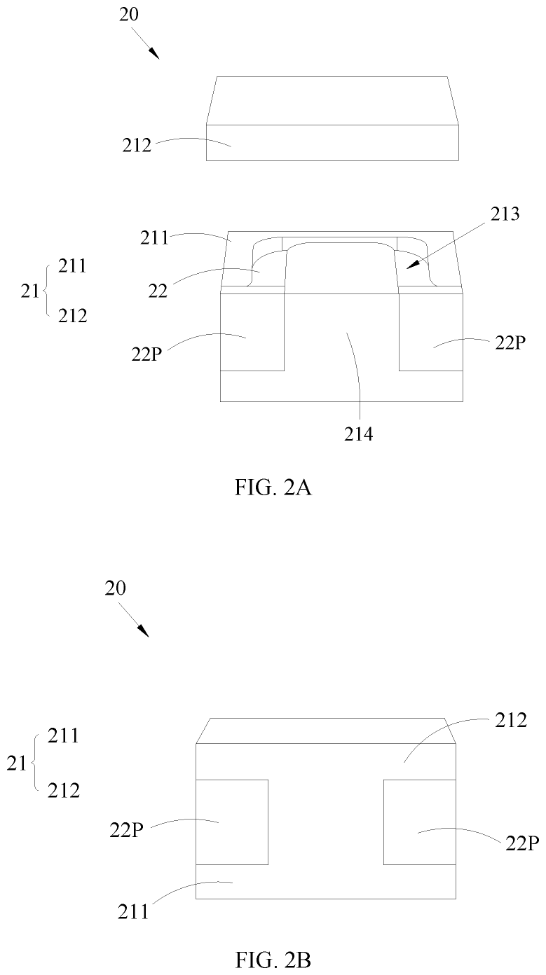

Please refer to FIG. 2A and FIG. 2B, which are schematic diagrams of the power inductor device and manufacturing method of the power inductor device in accordance with the second embodiment of the present disclosure. FIG. 2A is the schematic diagram of the manufacturing the power inductor device 20. FIG. 2B is the schematic diagram of the power inductor device 20.

As shown in FIG. 2A, the power inductor device 20 includes a magnetic core body 21 and a metal conductor 22. The magnetic core body 21 includes a first magnetic core 211 and a cover core 212. The first magnetic core 211 is a rectangle structure having a groove 213 at one side and a columnar magnetic body 214 is disposed in the groove 213 to form a U-shaped groove. the U-shaped groove has openings at both ends.

The first cover core 212 is a plate structure having a channel corresponding to the U-shaped groove. That is, the channel is also U-shape. When the cover core 212 covers the top side of the first magnetic core 211, the U-shaped groove and the channel may form a space for disposing the metal conductor 22. In the present embodiment, the magnetic core body 21 may be rectangular shape with single U-shape groove and plate structure in I shape. However, the present disclosure is not limited to these structures. In other embodiment, the magnetic core body 21 may include rectangular shape, E shape, U shape, rectangular shape with dual grooves, rectangular shape with multiple grooves, polygonal shape with single groove, polygonal shape with dual grooves or polygonal shape with multiple grooves.

As shown in the FIG. 2A, the metal conductor 22 is placed in the U-shaped groove and two ends of the metal conductor 22 pass through the openings. The cover core 212 covers the first magnetic core 211 and the metal conductor 22. The two ends of the metal conductor 22 pass through the openings. That is, the magnetic core body 21 and the metal conductor 22 are assembled by an assembly process. The two ends of the metal conductor 22 are exposed outside the magnetic core body 21. The metal conductor 22 may be made by gold, silver, copper, nickel or aluminum. The metal conductor 22 may be a metal coil. The coil number of the metal conductor 22 may be 0.25N and N is an integer of 2 or more. The two ends of the metal conductor 22 can be bended toward inside or outside the device to form the electrode pins 22P of the power inductor device 20. The bended coil may increase the welding area and welding strength of the electrode pins 22P. In the present embodiment, the metal conductor 22 has two pins 22P.

After the assembly process, a heating and pressing molding process is conducted to the magnetic core body 21 and the metal conductor 22 to form a combination structure. The forming pressure of the heating and pressing molding process may be 5-15 T/cm³. After that, a section heating process, a calcining process, a tempering process and a cooling process are conducted to the combination structure to obtain an integrated power inductor structure with crystallized structures.

The crystallized structures mean that the magnetic powder of the magnetic core body 21 is closely combined with the metal conductor 22 and the magnetic powder is partially embedded into a skin layer of the metal conductor 22 to obtain an integrated power inductor structure. In the present embodiment, the section heating process may heat up the magnetic core and the metal conductor from 25° C. to 850° C. in gradual section, the process time of the calcining process and the tempering process is 5-12 hours, and the cooling process cools down to 25° C. in gradual section.

In order to make the crystallized structures, the magnetic core body 21 may be formed by a magnetic powder and the magnetic powder has a particle size range between 10 nm-35μm. In the present embodiment, the magnetic powder for forming the first magnetic core 211 and the cover core 212 are the same or different. The magnetic powder may include an iron-based soft magnetic powder mixed with an adhesive, the iron-based soft magnetic powder include carbonyl (CIP), iron silicon chromium (Fe—Si—Cr), iron silicon aluminum (Fe—Si—Al), iron silicon (Fe—Si), amorphous, nanocrystalline alloy, iron nickel (FeNi), MPP iron nickel molybdenum (FeNiMo—C), silicon (Si), iron cobalt nickel (Fe—Co—Ni), manganese zinc (MnZn), nickel zinc (NiZn) or a combination thereof, the adhesive include an organic resin, an epoxy resin or an aldehyde resin having 1.5%-4.5% of unit weight. In addition, the magnetic powder may further include nickel (Ne), manganese (Mn), magnesium (Mg), copper (Cu), zinc (Zn), boron (B), lithium (Li), sodium (Na), carbon (C), cobalt (Co), niobium (Nb), barium (Ba), palladium (Pd), potassium (K), bismuth (Bi), graphene, amorphous, nanocrystalline (Nanocrystalline Alloy), a combination of above metals, or metal oxide or metal carbonate with above metals.

In the present embodiment, the particle size of the magnetic powder may include a first particle size, a second particle size and a third particle size. The first particle size is the smallest powder and the particle size is 10 nm-5 μm. The second particle size is the middle powder and the particle size is 8.5 μm-15 μm. The third particle size is the largest powder and the particle size is 18 μm-35 μm. The smaller size powder may lower the powder loss, lower the magnetic permeability and to obtain the better magnetic saturation capability. However, the smaller size powder is more expensive than the larger size powder. Using different sizes of the powder may obtain a balance between the effectiveness and the cost.

As shown in FIG. 2B, the power inductor device 20 is the integrated power inductor structure. The magnetic core body 21 is closely combined with the metal conductor 22 without generating air gap during the manufacturing process. Therefore, the characteristics of the inductor can be improved. The integrated power inductor structure also inhibits the split up or fall off problem between the magnetic core body 21 and the metal conductor 22. In other embodiment, the power inductor device 20 may further include an insulation layer, the insulation layer covers outside surface of the magnetic core body 21 and the two ends of the metal conductor 22 are exposed outside the insulation layer. The insulation layer may be formed by spray painting process. After spray painting process, a laser stripping process and an electroplating treatment can be used to remove partial insulation layer for exposing the two ends of the metal conductor 22.

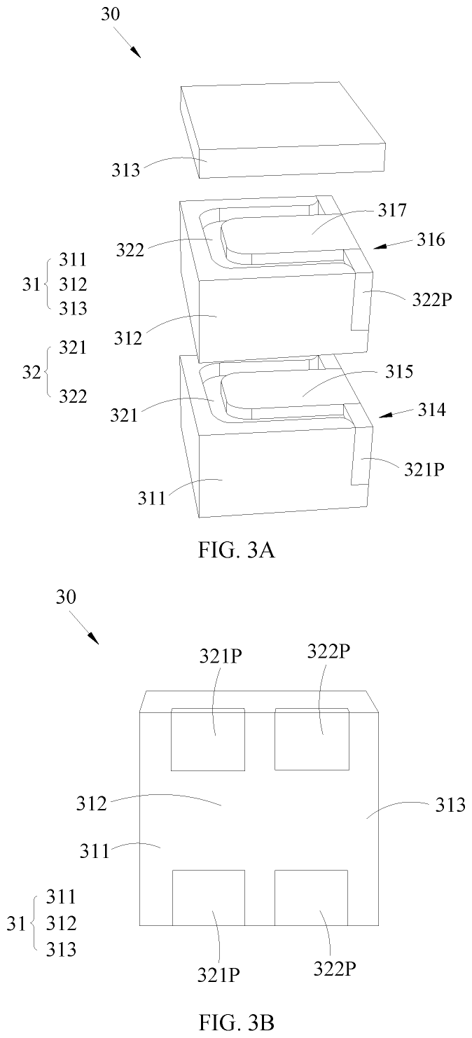

Please refer to 3A and FIG. 3B, which are schematic diagrams of the power inductor device and manufacturing method of the power inductor device in accordance with the third embodiment of the present disclosure. FIG. 3A is the schematic diagram of the manufacturing the power inductor device 30. FIG. 3B is the schematic diagram of the power inductor device 30.

As shown in FIG. 3A, the power inductor device 30 includes a magnetic core body 31 and a metal conductor 32. The magnetic core body 31 includes a first magnetic core 311, a second magnetic core 312 and a cover core 313. The metal conductor 32 includes a first metal conductor 321 and a second metal conductor 322. The first magnetic core 311 is a rectangle structure having a first groove 314 at one side and a columnar magnetic body 315 is disposed in the first groove 314 to form a first U-shaped groove, the first U-shaped groove has first openings at both ends. The second magnetic core 312 is another rectangle structure having a second groove 316 at one side and a first channel at another side corresponding to the first U-shaped groove, the first channel may be the same U-shape like the first U-shaped groove. Another columnar magnetic body 317 is disposed in the second groove 316 to form a second U-shaped groove, the second U-shaped groove has second openings at both ends. The first openings and the second openings facing the same direction. The first U-shaped groove and the second U-shaped groove are not connected.

The cover core 312 is a plate structure having a second channel corresponding to the second U-shaped groove. The first channel is also the same U-shape like the second U-shaped groove. When the second magnetic core 312 covers the first magnetic core 311 and the cover core 312 covers the second magnetic core 311, the first U-shaped groove and the first channel may form a space for disposing the first metal conductor 321, and the second U-shaped groove and the second channel may form another space for disposing the second metal conductor 322. In the present embodiment, the magnetic core body 31 may be rectangular shape with single U-shape grooves or multiple grooves and plate structure in I shape. However, the present disclosure is not limited to these structures. In other embodiment, the magnetic core body 31 may include rectangular shape, E shape, U shape, rectangular shape with single groove, polygonal shape with single groove, polygonal shape with dual grooves or polygonal shape with multiple grooves.

During the assembly process, the first metal conductor 321 is placed in the first U-shaped groove and two ends of the first metal conductor 321 pass through the first openings. The second metal conductor 322 is placed in the second U-shaped groove and two ends of the second metal conductor 322 pass through the second openings. The cover core 312 covers the second magnetic core 312 and the second metal conductor 322. That is, the magnetic core body 31 and the metal conductor 32 are assembled in the assembly process. The two ends of the metal conductor 32 are exposed outside the magnetic core body 31. The metal conductor 32 may be made by gold, silver, copper, nickel or aluminum. The metal conductor 32 may be a metal coil. The coil number of the metal conductor 32 may be 0.25N and N is an integer of 2 or more. The two ends of the metal conductor 2 can be bended toward inside or outside the device to form the electrode pins of the power inductor device 30. The bended coil may increase the welding area and welding strength of the electrode pins. In the present embodiment, the first metal conductor 321 has two pins 321P and the second metal conductor 322 has two pins 322P.

After the assembly process, a heating and pressing molding process is conducted to the magnetic core body 31 and the metal conductor 32 to form a combination structure. The forming pressure of the heating and pressing molding process may be 5-15 T/cm³. After that, a section heating process, a calcining process, a tempering process and a cooling process are conducted to the combination structure to obtain an integrated power inductor structure with crystallized structures.

The crystallized structures mean that the magnetic powder of the magnetic core body 31 is closely combined with the metal conductor 32 and the magnetic powder is partially embedded into a skin layer of the metal conductor 32 to obtain an integrated power inductor structure. In the present embodiment, the section heating process may heat up the magnetic core and the metal conductor from 25° C. to 850° C. in gradual section, the process time of the calcining process and the tempering process is 5-12 hours, and the cooling process cools down to 25° C. in gradual section.

In the present disclosure, the magnetic core body 31 may be formed by a magnetic powder and the magnetic powder has a particle size range between 10 nm-35 μm. In the present embodiment, the magnetic powder for forming the first magnetic core 311, the first cover core 312 and the second cover core 313 are the same or different. The magnetic powder may include an iron-based soft magnetic powder mixed with an adhesive, the iron-based soft magnetic powder include carbonyl (CIP), iron silicon chromium (Fe—Si—Cr), iron silicon aluminum (Fe—Si—Al), iron silicon (Fe—Si), amorphous, nanocrystalline alloy, iron nickel (FeNi), MPP iron nickel molybdenum (FeNiMo—C), silicon (Si), iron cobalt nickel (Fe—Co—Ni), manganese zinc (MnZn), nickel zinc (NiZn) or a combination thereof, the adhesive include an organic resin, an epoxy resin or an aldehyde resin having 1.5%-4.5% of unit weight. In addition, the magnetic powder may further include nickel (Ne), manganese (Mn), magnesium (Mg), copper (Cu), zinc (Zn), boron (B), lithium (Li), sodium (Na), carbon (C), cobalt (Co), niobium (Nb), barium (Ba), palladium (Pd), potassium (K), bismuth (Bi), graphene, amorphous, nanocrystalline (Nanocrystalline Alloy), a combination of above metals, or metal oxide or metal carbonate with above metals.

In the present embodiment, the particle size of the magnetic powder may include a first particle size, a second particle size and a third particle size. The first particle size is the smallest powder and the particle size is 10 nm-5 μm. The second particle size is the middle powder and the particle size is 8.5 μm-15 μm. The third particle size is the largest powder and the particle size is 18 μm-35 μm. The smaller size powder may lower the powder loss, lower the magnetic permeability and to obtain the better magnetic saturation capability. However, the smaller size powder is more expensive than the larger size powder. Using different sizes of the powder may obtain a balance between the effectiveness and the cost.

As shown in FIG. 3B, the power inductor device 30 is the integrated power inductor structure. The magnetic core body 31 is closely combined with the metal conductor 32 without generating air gap during the manufacturing process. Therefore, the characteristics of the inductor can be improved. The integrated power inductor structure also inhibits the split up or fall off problem between the magnetic core body 31 and the metal conductor 32. In other embodiment, the power inductor device 30 may further include an insulation layer, the insulation layer covers outside surface of the magnetic core body 31 and the two ends of the metal conductor are exposed outside the insulation layer. The insulation layer may be formed by spray painting process. After spray painting process, a laser stripping process and an electroplating treatment can be used to remove partial insulation layer for exposing the two ends of the metal conductor 32.

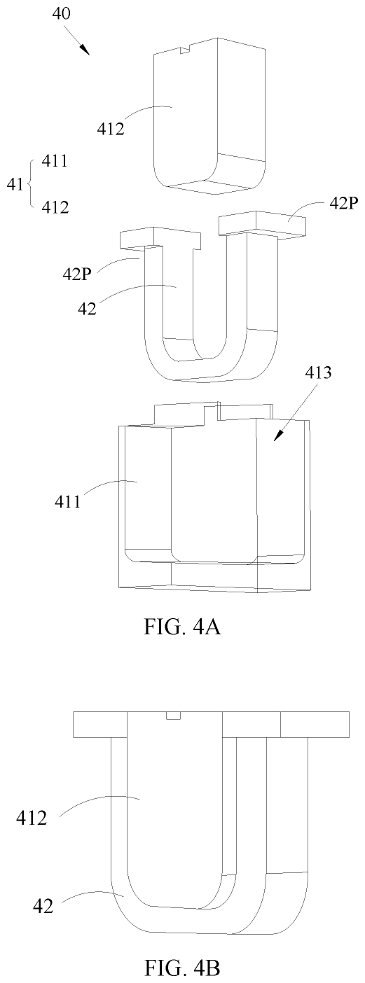

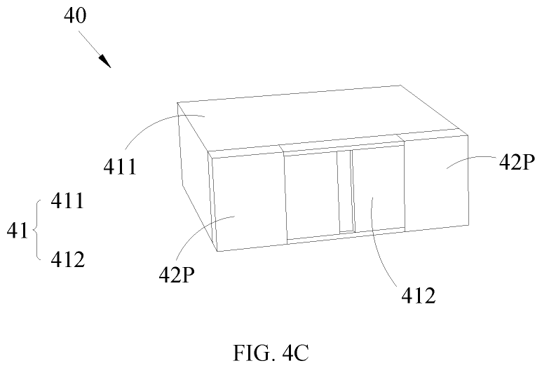

Please refer to FIG. 4A to FIG. 4C, which are schematic diagrams of the power inductor device and manufacturing method of the power inductor device in accordance with the fourth embodiment of the present disclosure. FIG. 4A and FIG. 4B are the schematic diagrams of the manufacturing the power inductor device 40. FIG. 4C is the schematic diagram of the power inductor device 40.

As shown in FIG. 4A, the power inductor device 40 includes a magnetic core body 41 and a metal conductor 42. The magnetic core body 41 includes a first magnetic core 411 and a bar core 412. The first magnetic core 411 is a rectangle structure having a groove 413 at one side. The groove 413 has an opening toward top side of the first magnetic core 411. The bar core 412 is a columnar body with curve bottom. The bar core 412 is smaller than the groove 413 and can be disposed in the groove 413 for forming a U-shaped groove. The U-shaped groove has openings at both ends. In the present embodiment, the magnetic core body 41 may be rectangular shape with single groove and polygonal shape. However, the present disclosure is not limited to these structures. In other embodiment, the magnetic core body 41 may include rectangular shape, E shape, U shape, rectangular shape with dual grooves, rectangular shape with multiple grooves, polygonal shape with single groove, polygonal shape with dual grooves or polygonal shape with multiple grooves.

As shown in the FIG. 4A, the metal conductor 42 is placed in the U-shaped groove and the bar core 412 is placed on the metal conductor 42. The two ends of the metal conductor 42 pass through the openings. The metal conductor 42 and the bar core 412 may fill up the groove 413. However, the assembly process sequence can be changed. In other embodiment, as shown in FIG. 4B, the metal conductor 42 and the bar core 412 can be assembled first and then be placed in the groove 413 of the first magnetic core 411. The magnetic core body 41 and the metal conductor 42 are assembled by an assembly process. The two ends of the metal conductor 42 are exposed outside the magnetic core body 41. The metal conductor 42 may be made by gold, silver, copper, nickel or aluminum. The metal conductor 42 may be a metal coil. The coil number of the metal conductor 42 may be 0.25N and N is an integer of 2 or more. The two ends of the metal conductor 42 can be bended toward inside or outside the device to form the electrode pins 42P of the power inductor device 40. The bended coil may increase the welding area and welding strength of the electrode pins 42P. In the present embodiment, the metal conductor 42 has two pins 42P.

After the assembly process, a heating and pressing molding process is conducted to the magnetic core body 41 and the metal conductor 42 to form a combination structure. The forming pressure of the heating and pressing molding process may be 5-15 T/cm³. After that, a section heating process, a calcining process, a tempering process and a cooling process are conducted to the combination structure to obtain an integrated power inductor structure with crystallized structures.

The crystallized structures mean that the magnetic powder of the magnetic core body 41 is closely combined with the metal conductor 42 and the magnetic powder is partially embedded into a skin layer of the metal conductor 42 to obtain an integrated power inductor structure. In the present embodiment, the section heating process may heat up the magnetic core and the metal conductor from 25° C. to 850° C. in gradual section, the process time of the calcining process and the tempering process is 5-12 hours, and the cooling process cools down to 25° C. in gradual section.

In the present disclosure, the magnetic core body 41 may be formed by a magnetic powder and the magnetic powder has a particle size range between 10 nm-35 μm. In the present embodiment, the magnetic powder for forming the first magnetic core 411 and the bar core 412 are the same or different. The magnetic powder may include an iron-based soft magnetic powder mixed with an adhesive, the iron-based soft magnetic powder include carbonyl (CIP), iron silicon chromium (Fe—Si—Cr), iron silicon aluminum (Fe—Si—Al), iron silicon (Fe—Si), amorphous, nanocrystalline alloy, iron nickel (FeNi), MPP iron nickel molybdenum (FeNiMo—C), silicon (Si), iron cobalt nickel (Fe—Co—Ni), manganese zinc (MnZn), nickel zinc (NiZn) or a combination thereof, the adhesive include an organic resin, an epoxy resin or an aldehyde resin having 1.5%-4.5% of unit weight. In addition, the magnetic powder may further include nickel (Ne), manganese (Mn), magnesium (Mg), copper (Cu), zinc (Zn), boron (B), lithium (Li), sodium (Na), carbon (C), cobalt (Co), niobium (Nb), barium (Ba), palladium (Pd), potassium (K), bismuth (Bi), graphene, amorphous, nanocrystalline (Nanocrystalline Alloy), a combination of above metals, or metal oxide or metal carbonate with above metals.

In the present embodiment, the particle size of the magnetic powder may include a first particle size, a second particle size and a third particle size. The first particle size is the smallest powder and the particle size is 10 nm-5 μm. The second particle size is the middle powder and the particle size is 8.5 μm-15 μm. The third particle size is the largest powder and the particle size is 18 μm-35 μm. The smaller size powder may lower the powder loss, lower the magnetic permeability and to obtain the better magnetic saturation capability. However, the smaller size powder is more expensive than the larger size powder. Using different sizes of the powder may obtain a balance between the effectiveness and the cost.

As shown in FIG. 4C, the power inductor device 40 is the integrated power inductor structure. The magnetic core body 41 is closely combined with the metal conductor 42 without generating air gap during the manufacturing process. Therefore, the characteristics of the inductor can be improved. The integrated power inductor structure also inhibits the split up or fall off problem between the magnetic core body 41 and the metal conductor 42. In other embodiment, the power inductor device 40 may further include an insulation layer, the insulation layer covers outside surface of the magnetic core body 41 and the two ends of the metal conductor 42 are exposed outside the insulation layer. The insulation layer may be formed by spray painting process. After spray painting process, a laser stripping process and an electroplating treatment can be used to remove partial insulation layer for exposing the two ends of the metal conductor 42.

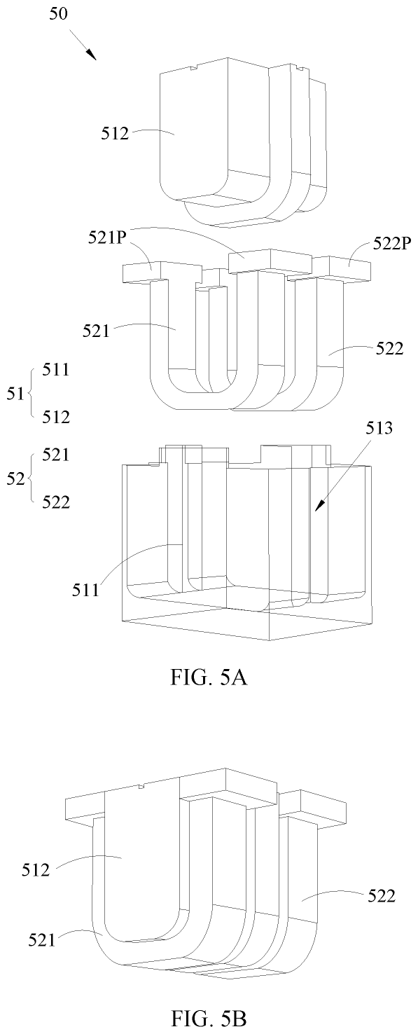

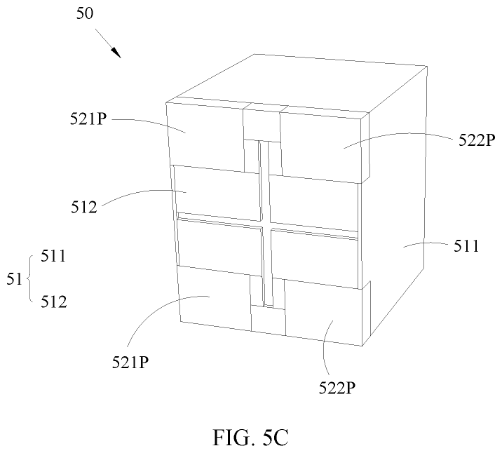

Please refer to FIG. 5A to FIG. 5C, which are schematic diagrams of the power inductor device and manufacturing method of the power inductor device in accordance with the fifth embodiment of the present disclosure. FIG. 5A and FIG. 5B are the schematic diagrams of the manufacturing the power inductor device 50. FIG. 5C is the schematic diagram of the power inductor device 50.

As shown in FIG. 5A, the power inductor device 50 includes a magnetic core body 51 and a metal conductor 52. The magnetic core body 51 includes a first magnetic core 511 and a bar core 512. The first magnetic core 511 is a rectangle structure having a groove 513 at one side. The groove 513 has an opening toward top side of the first magnetic core 511. The bar core 512 is a cross cylinder body with curve bottom. The bar core 512 is smaller than the groove 513 and can be disposed in the groove 513. The cross cylinder body has different depths at the bottom side of the bar core 512, so as to form the a first U-shaped groove and the second U-shaped groove, the first U-shaped groove has first openings at both ends and the second U-shaped groove has second openings at both ends, the first U-shaped groove and the second U-shaped groove are not connected. In the present embodiment, the magnetic core body 51 may be rectangular shape with single groove and polygonal shape. However, the present disclosure is not limited to these structures. In other embodiment, the magnetic core body 51 may include rectangular shape, E shape, U shape, rectangular shape with dual grooves, rectangular shape with multiple grooves, polygonal shape with single groove, polygonal shape with dual grooves or polygonal shape with multiple grooves.

As shown in the FIG. 5A, the metal conductor 52 include a first metal conductor 521 and a second metal conductor 522. The first metal conductor 521 is placed in the first U-shaped groove and the second metal conductor 522 is placed in the second U-shaped groove. The bar core 512 is placed on the first metal conductor 521 and the second metal conductor 522. The two ends of the first metal conductor 521 pass through the first openings and the two ends of the second metal conductor 522 pass through the second openings. The first metal conductor 521, the second metal conductor 522 and the bar core 512 may fill up the groove 513. However, the assembly process sequence can be changed. In other embodiment, as shown in FIG. 5B, the first metal conductor 521, the second metal conductor 522 and the bar core 512 can be assembled first and then be placed in the groove 513 of the first magnetic core 511. The magnetic core body 51 and the metal conductor 52 are assembled by an assembly process. The two ends of the metal conductor 52 are exposed outside the magnetic core body 51. The metal conductor 52 may be made by gold, silver, copper, nickel or aluminum. The metal conductor 52 may be a metal coil. The coil number of the metal conductor 52 may be 0.25N and N is an integer of 2 or more. The two ends of the metal conductor 52 can be bended toward inside or outside the device to form the electrode pins of the power inductor device 50. The bended coil may increase the welding area and welding strength of the electrode pins. In the present embodiment, the first metal conductor 521 has two pins 521P and the second metal conductor 522 has two pins 522P.

After the assembly process, a heating and pressing molding process is conducted to the magnetic core body 51 and the metal conductor 52 to form a combination structure. The forming pressure of the heating and pressing molding process may be 5-15 T/cm³. After that, a section heating process, a calcining process, a tempering process and a cooling process are conducted to the combination structure to obtain an integrated power inductor structure with crystallized structures.

The crystallized structures mean that the magnetic powder of the magnetic core body 51 is closely combined with the metal conductor 52 and the magnetic powder is partially embedded into a skin layer of the metal conductor 52 to obtain an integrated power inductor structure. In the present embodiment, the section heating process may heat up the magnetic core and the metal conductor from 25° C. to 850° C. in gradual section, the process time of the calcining process and the tempering process is 5-12 hours, and the cooling process cools down to 25° C. in gradual section.

In the present disclosure, the magnetic core body 51 may be formed by a magnetic powder and the magnetic powder has a particle size range between 10 nm-35 μm. In the present embodiment, the magnetic powder for forming the first magnetic core 511 and the bar core 512 are the same or different. The magnetic powder may include an iron-based soft magnetic powder mixed with an adhesive, the iron-based soft magnetic powder include carbonyl (CIP), iron silicon chromium (Fe—Si—Cr), iron silicon aluminum (Fe—Si—Al), iron silicon (Fe—Si), amorphous, nanocrystalline alloy, iron nickel (FeNi), MPP iron nickel molybdenum (FeNiMo—C), silicon (Si), iron cobalt nickel (Fe—Co—Ni), manganese zinc (MnZn), nickel zinc (NiZn) or a combination thereof, the adhesive include an organic resin, an epoxy resin or an aldehyde resin having 1.5%-4.5% of unit weight. In addition, the magnetic powder may further include nickel (Ne), manganese (Mn), magnesium (Mg), copper (Cu), zinc (Zn), boron (B), lithium (Li), sodium (Na), carbon (C), cobalt (Co), niobium (Nb), barium (Ba), palladium (Pd), potassium (K), bismuth (Bi), graphene, amorphous, nanocrystalline (Nanocrystalline Alloy), a combination of above metals, or metal oxide or metal carbonate with above metals.

In the present embodiment, the particle size of the magnetic powder may include a first particle size, a second particle size and a third particle size. The first particle size is the smallest powder and the particle size is 10 nm-5 μm. The second particle size is the middle powder and the particle size is 8.5 μm-15 μm. The third particle size is the largest powder and the particle size is 18 μm-35 μm. The smaller size powder may lower the powder loss, lower the magnetic permeability and to obtain the better magnetic saturation capability. However, the smaller size powder is more expensive than the larger size powder. Using different sizes of the powder may obtain a balance between the effectiveness and the cost.

As shown in FIG. 5C, the power inductor device 50 is the integrated power inductor structure. The magnetic core body 51 is closely combined with the metal conductor 52 without generating air gap during the manufacturing process. Therefore, the characteristics of the inductor can be improved. The integrated power inductor structure also inhibits the split up or fall off problem between the magnetic core body 51 and the metal conductor 52. In other embodiment, the power inductor device 50 may further include an insulation layer, the insulation layer covers outside surface of the magnetic core body 51 and the two ends of the metal conductor 52 are exposed outside the insulation layer. The insulation layer may be formed by spray painting process. After spray painting process, a laser stripping process and an electroplating treatment can be used to remove partial insulation layer for exposing the two ends of the metal conductor 52.

The above embodiments provide several examples to the power inductor device. However, the present disclosure is not limited to this. In other embodiments, the shape or the numbers of the magnetic core body and the metal conductor can be different. The design can be decided by the requirements of the electronic components.

The present disclosure disclosed herein has been described by means of specific embodiments. However, numerous modifications, variations and enhancements can be made thereto without departing from the spirit and scope of the disclosure set forth in the claims.

What is claimed is:

1. A power inductor device comprising:
a magnetic core body being formed by a magnetic powder and the magnetic powder having a particle size range between 10 nm-35 μm; and
a metal conductor disposed in the magnetic core body and two ends of the metal conductor being exposed outside the magnetic core body, the magnetic powder being closely combined with the metal conductor and the magnetic powder being partially embedded into a skin layer of the metal conductor to obtain an integrated power inductor structure with crystallized structures;
wherein the magnetic core and the metal conductor are assembled and formed by a heating and pressing molding process, and the crystallized structures are generated by a section heating process, a calcining process, a tempering process and a cooling process.

2. The power inductor device of claim 1, wherein the magnetic powder comprises an iron-based soft magnetic powder mixed with an adhesive, the iron-based soft magnetic powder comprises carbonyl, iron silicon chromium, iron silicon aluminum, iron silicon, amorphous, nanocrystalline alloy, iron nickel, MPP iron nickel molybdenum, silicon, iron cobalt nickel, manganese zinc, nickel zinc or a combination thereof, the adhesive comprises an organic resin, an epoxy resin or an aldehyde resin having 1.5%-4.5% of unit weight.

3. The power inductor device of claim 2, wherein the magnetic powder further comprises nickel, manganese, magnesium, copper, zinc, boron, lithium, sodium, carbon, cobalt, niobium, barium, palladium, potassium, bismuth, graphene, amorphous, nanocrystalline, a combination of above metals, or metal oxide or metal carbonate with above metals.

4. The power inductor device of claim 1, wherein the particle size comprises a first particle size, a second particle size and a third particle size, the first particle size is 10 nm-5 μm, the second particle size is 8.5 μm-15 μm, and the third particle size is 18 μm-35 μm.

5. The power inductor device of claim 1, wherein the metal conductor is made by gold, silver, copper, nickel or aluminum.

6. The power inductor device of claim 1, wherein the magnetic core body comprises a first cover core, a first magnetic core and a second cover core, the magnetic powders for forming the first cover core, the first magnetic core and the second cover core are the same or different;
wherein the first magnetic core is a rectangle structure having a first groove at one side and a second groove at another side, a columnar magnetic body is disposed between the first groove and the second groove to form a first U-shaped groove and a second U-shaped groove, the first U-shaped groove has first openings at both ends and the second U-shaped groove has second openings at both ends;
wherein the first cover core is a plate structure having a first channel corresponding to the first U-shaped groove;
wherein the second cover core is another plate structure having a second channel corresponding to the second U-shaped groove, the first U-shaped groove and the second U-shaped groove are not connected;
wherein the metal conductor comprises a first metal conductor and a second metal conductor, the first metal conductor is disposed in the first U-shaped groove and two ends of the first metal conductor pass through the first openings, the second metal conductor is disposed in the second U-shaped groove and two ends of the second metal conductor pass through the second openings.

7. The power inductor device of claim 1, wherein the magnetic core body comprises a first magnetic core and a cover core, the magnetic powders for forming the first magnetic core and the cover core are the same or different;
wherein the first magnetic core is a rectangle structure having a groove at one side and a columnar magnetic body is disposed in the groove to form a U-shaped groove, the U-shaped groove has openings at both ends;
wherein the cover core is a plate structure having a channel corresponding to the U-shaped groove;
wherein the metal conductor is disposed in the U-shaped groove and two ends of the metal conductor pass through the openings.

8. The power inductor device of claim 1, wherein the magnetic core body comprises a first magnetic core, a second magnetic core and a cover core, the magnetic powders for forming the first magnetic core, the second magnetic core and the cover core are the same or different;
wherein the first magnetic core is a rectangle structure having a first groove at one side and a columnar magnetic body is disposed in the first groove to form a first U-shaped groove, the first U-shaped groove has first openings at both ends;
wherein the second magnetic core is another rectangle structure having a second groove at one side and a first channel at another side corresponding to the first U-shaped groove, a columnar magnetic body is disposed in the second groove to form a second U-shaped groove, the second U-shaped groove has second openings at both ends;
wherein the cover core is a plate structure having a second channel corresponding to the second U-shaped groove, the first U-shaped groove and the second U-shaped groove are not connected;
wherein the metal conductor comprises a first metal conductor and a second metal conductor, the first metal conductor is disposed in the first U-shaped groove and two ends of the first metal conductor pass through the first openings, the second metal conductor is disposed in the second U-shaped groove and two ends of the second metal conductor pass through the second openings.

9. The power inductor device of claim 1, wherein the magnetic core body comprises a first magnetic core and a bar core, the magnetic powders for forming the first magnetic core and the bar core are the same or different;
wherein the first magnetic core is a rectangle structure having a groove at one side;
wherein the bar core is a columnar body disposed in the groove for forming a U-shaped groove, the U-shaped groove has openings at both ends;
wherein the metal conductor is disposed in the U-shaped groove and two ends of the metal conductor pass through the openings.

10. The power inductor device of claim 1, wherein the magnetic core body comprises a first magnetic core and a bar core, the magnetic powders for forming the first magnetic core and the bar core are the same or different;
wherein the first magnetic core is a rectangle structure having a groove at one side;
wherein the bar core is a cross cylinder body disposed in the groove for forming a first U-shaped groove and the second U-shaped groove, the first U-shaped groove has first openings at both ends and the second U-shaped groove has second openings at both ends, the first U-shaped groove and the second U-shaped groove are not connected;
wherein the metal conductor comprises a first metal conductor and a second metal conductor, the first metal conductor is disposed in the first U-shaped groove and two ends of the first metal conductor pass through the first openings, the second metal conductor is disposed in the second U-shaped groove and two ends of the second metal conductor pass through the second openings.

11. The power inductor device of claim 1, wherein the magnetic core body comprises rectangular shape, E shape, I shape, U shape, rectangular shape with single groove, rectangular shape with dual grooves, rectangular shape with multiple grooves, polygonal shape with single groove, polygonal shape with dual grooves or polygonal shape with multiple grooves.

12. The power inductor device of claim 1, wherein a coil number of the metal conductor is 0.25N and N is an integer of 2 or more.

13. The power inductor device of claim 1, wherein forming pressure of the heating and pressing molding process is 5-15 T/cm³.

14. The power inductor device of claim 1, wherein the section heating process heats up the magnetic core and the metal conductor from 25° C. to 850° C. in gradual section, the process time of the calcining process and the tempering process is 5-12 hours, and the cooling process cools down to 25° C. in gradual section.

15. The power inductor device of claim 1, further comprising an insulation layer, the insulation layer covering outside surface of the magnetic core body and the two ends of the metal conductor being exposed outside the insulation layer.

16. A manufacturing method of a power inductor device, the manufacturing method comprising following steps of:
providing a magnetic core body and a metal conductor, the magnetic core body being formed by a magnetic powder and the magnetic powder having a particle size range between 10 nm-35 μm;
assembling the magnetic core body and the metal conductor, the metal conductor being placing in the magnetic core body and two ends of the metal conductor being exposed outside the magnetic core body;
conducting a heating and pressing molding process to the magnetic core body and the metal conductor to form a combination structure;
conducting a section heating process, a calcining process, a tempering process and a cooling process to the combination structure to obtain an integrated power inductor structure with crystallized structures.

17. The manufacturing method of claim 16, wherein the magnetic powder comprises an iron-based soft magnetic powder mixed with an adhesive, the iron-based soft magnetic powder comprises carbonyl, iron silicon chromium, iron silicon aluminum, iron silicon, amorphous, nanocrystalline alloy, iron nickel, MPP iron nickel molybdenum, silicon, iron cobalt nickel, manganese zinc, nickel zinc or a combination thereof, the adhesive comprises an organic resin, an epoxy resin or an aldehyde resin having 1.5%-4.5% of unit weight.

18. The manufacturing method of claim 17, wherein the magnetic powder further comprises nickel, manganese, magnesium, copper, zinc, boron, lithium, sodium, carbon, cobalt, niobium, barium, palladium, potassium, bismuth, graphene, amorphous, nanocrystalline, a combination of above metals, or metal oxide or metal carbonate with above metals.

19. The manufacturing method of claim 16, wherein the particle size comprises a first particle size, a second particle size and a third particle size, the first particle size is 10 nm-5 μm, the second particle size is 8.5 μm-15 μm, and the third particle size is 18 μm-35 μm.

20. The manufacturing method of claim 16, wherein the metal conductor is made by gold, silver, copper, nickel or aluminum.

21. The manufacturing method of claim 16, further comprises the steps of:
providing a first magnetic core with a rectangle structure having a first groove at one side and a second groove at another side, a columnar magnetic body is disposed between the first groove and the second groove to form a first U-shaped groove and a second U-shaped groove, the first U-shaped groove has first openings at both ends and the second U-shaped groove has second openings at both ends;
providing a first cover core with a plate structure having a first channel corresponding to the first U-shaped groove;
placing a first metal conductor in the first U-shaped groove and two ends of the first metal conductor pass through the first openings;
providing a second cover core with another plate structure having a second channel corresponding to the second U-shaped groove, the first U-shaped groove and the second U-shaped groove are not connected;
placing a second metal conductor in the second U-shaped groove and two ends of the second metal conductor pass through the second openings.

22. The manufacturing method of claim 16, further comprises the steps of:
providing a first magnetic core with a rectangle structure having a groove at one side and a columnar magnetic body is disposed in the groove to form a U-shaped groove, the U-shaped groove has openings at both ends;
providing a cover core with a plate structure having a channel corresponding to the U-shaped groove;
placing the metal conductor in the U-shaped groove and two ends of the metal conductor pass through the openings.

23. The manufacturing method of claim 16, further comprises the steps of:
providing a first magnetic core with a rectangle structure having a first groove at one side and a columnar magnetic body is disposed in the first groove to form a first U-shaped groove, the first U-shaped groove has first openings at both ends;
providing a second magnetic core with another rectangle structure having a second groove at one side and a first channel at another side corresponding to the first U-shaped groove, a columnar magnetic body is disposed in the second groove to form a second U-shaped groove, the second U-shaped groove has second openings at both ends;
providing a cover core with a plate structure having a second channel corresponding to the second U-shaped groove, the first U-shaped groove and the second U-shaped groove are not connected;
placing a first metal conductor in the first U-shaped groove and two ends of the first metal conductor pass through the first openings;
placing a second metal conductor in the second U-shaped groove and two ends of the second metal conductor pass through the second openings.

24. The manufacturing method of claim 16, further comprises the steps of:
providing a first magnetic core with a rectangle structure having a groove at one side;
providing a bar core with a columnar body, the columnar body and the first magnetic core form a U-shaped groove and the U-shaped groove has openings at both ends;
placing the metal conductor in the U-shaped groove and two ends of the metal conductor pass through the openings.

25. The manufacturing method of claim 16, further comprises the steps of:
providing a first magnetic core with a rectangle structure having a groove at one side;
providing a bar core with a cross cylinder body, the bar core and the first magnetic core form a first U-shaped groove and the second U-shaped groove, the first U-shaped groove has first openings at both ends and the second U-shaped groove has second openings at both ends, the first U-shaped groove and the second U-shaped groove are not connected;
placing a first metal conductor in the first U-shaped groove and two ends of the first metal conductor pass through the first openings;
placing a second metal conductor in the second U-shaped groove and two ends of the second metal conductor pass through the second openings.

26. The manufacturing method of claim 16, wherein the magnetic core body comprises rectangular shape, E shape, I shape, U shape, rectangular shape with single groove, rectangular shape with dual grooves, rectangular shape with multiple grooves, polygonal shape with single groove, polygonal shape with dual grooves or polygonal shape with multiple grooves.

27. The manufacturing method of claim 16, wherein a coil number of the metal conductor is 0.25N and N is an integer of 2 or more.

28. The manufacturing method of claim 16, wherein forming pressure of the heating and pressing molding process is 5-15 T/cm³.

29. The manufacturing method of claim 16, wherein the section heating process heats up the magnetic core and the metal conductor from 25° C. to 850° C. in gradual section, the process time of the calcining process and the tempering process is 5-12 hours, and the cooling process cools down to 25° C. in gradual section.

30. The manufacturing method of claim 16, wherein an insulation layer is formed by spray painting to cover outside surface of the magnetic core body and the two ends of the metal conductor being exposed outside the insulation layer after a laser stripping process and a electroplating treatment.
